(19) United States
(12) Patent Application Publication
(10) Pub. No.: US 2025/0183322 A1
(43) Pub. Date: Jun. 5, 2025

(54) CURRENT COLLECTOR, ELECTRODE FOR POWER STORAGE DEVICE, AND LITHIUM ION SECONDARY BATTERY

(71) Applicant: TDK Corporation, Tokyo (JP)

(72) Inventors: Keisuke TATSUZAKI, Tokyo (JP); Yoshiyuki MURAKOSHI, Tokyo (JP); Shun IKENARI, Tokyo (JP); Kosuke TANAKA, Tokyo (JP)

(73) Assignee: TDK Corporation, Tokyo (JP)

(21) Appl. No.: 18/842,623

(22) PCT Filed: Mar. 2, 2022
(86) PCT No.: PCT/JP2022/008980

§ 371 Date: Aug. 29, 2024

(51) Int. Cl. H01M 4/66; H01M 10/0525

(52) U.S. Cl. CPC H01M 4/667; H01M 4/661; H01M 4/668; H01M 10/0525

(57) ABSTRACT

A current collector includes: a resin layer 10 having a first surface; and a first metal layer 20 located on the first surface, in which the first metal layer contains aluminum as a main component, the first metal layer has a thickness d of 0.5 μm or greater and 3 μm or less, and in measurement of the first metal layer by an X-ray diffraction method, when the peak intensity ratio B/A between an intensity A of a highest X-ray diffraction peak in a diffraction angle (2θ) range of 36° or greater and 41° or less, and an intensity B of a highest X-ray diffraction peak in a diffraction angle (2θ) range of 43° or greater and 48° or less is designated as r, d and r satisfy the following Formula (1):

$$0 \leq \frac{\sqrt{r}}{{d}^{2}} \leq 2.1 . \qquad ( 1 )$$

### TECHNICAL FIELD

The present disclosure relates to a current collector, an electrode for a power storage device, and a lithium ion secondary battery.

### BACKGROUND ART

It has been proposed to use a composite material in which a conductive layer is formed on one surface or both surfaces of a resin film, as a current collector for a secondary battery. Patent Literature 1 discloses a secondary battery in which such a composite material is applied to a current collector.

### CITATION LIST

### Patent Literature

Patent Literature 1: Specification of U.S. Patent Application Publication No. 2020/0373584

### SUMMARY OF INVENTION

### Technical Problem

When a current collector of the above-mentioned composite material is used for a power storage device including a non-aqueous liquid electrolyte, such as a lithium ion secondary battery, it is preferable that the current collector includes resistance to non-aqueous liquid electrolytes. An embodiment of the present disclosure provides a current collector having excellent resistance to non-aqueous liquid electrolytes, an electrode for a power storage device, and a lithium ion secondary battery.

### Solution to Problem

A current collector according to an embodiment of the present disclosure includes: a resin layer having a first surface and a second surface located on the opposite side of the first surface; and a first metal layer located on the first surface, in which the first metal layer contains aluminum as a main component, the first metal layer has a thickness d of 0.5 μm or greater and 3 μm or less, and in measurement of the first metal layer by an X-ray diffraction method, when a peak intensity ratio B/A between an intensity A of a highest X-ray diffraction peak in a diffraction angle (2θ) range of 36° or greater and 41° or less, and an intensity B of a highest X-ray diffraction peak in a diffraction angle (2θ) range of 43° or greater and 48° or less is designated as r, d and r satisfy the following Formula (1):

$$\begin{matrix}[ Mathematical Formula 1 ] & \\ 0 \leq \frac{\sqrt{r}}{{d}^{2}} \leq 2.1 & ( 1 )\end{matrix}$$

### ADVANTAGEOUS EFFECTS OF INVENTION

According to an embodiment of the present disclosure, a current

collector having excellent resistance to non-aqueous liquid electrolytes, an electrode for a power storage device, and a lithium ion secondary battery.

### BRIEF DESCRIPTION OF DRAWINGS

FIG. 1 is a schematic cross-sectional view illustrating an example of a current collector according to a first embodiment.

FIG. 2 illustrates an example of an X-ray diffraction chart of an aluminum thin film.

FIG. 3 is a schematic cross-sectional view illustrating an example of a current collector of a second embodiment.

FIG. 4 is a schematic exploded perspective view illustrating an example of an electrode for a power storage device of a third embodiment.

FIG. 5 is a schematic partial cutaway perspective view illustrating an example of a lithium ion secondary battery of a fourth embodiment.

FIG. 6 is a schematic exploded perspective view illustrating an example of a cell of the lithium ion secondary battery shown in FIG. 5.

FIG. 7 shows the diffraction angle (2θ) range of 43° to 48°, in which the peak of Al(200) is observed in the X-ray diffraction charts obtained from the samples of Examples 2, 5, and 7.

### DESCRIPTION OF EMBODIMENTS

A current collector in which a conductive layer is formed on a resin film is different from metal foils that have been conventionally used alone as current collectors, in terms of structure and thickness. Particularly, the above-mentioned current collector is different from conventional current collectors in that the conductive layer is supported by a resin film and is thinner than the metal foils used in conventional current collectors.

A lithium ion secondary battery generally includes a non-aqueous liquid electrolyte containing anions containing fluorine atoms as electrolytes. When the above-mentioned current collector is used in a lithium ion secondary battery, the current collector needs to include appropriate resistance to non-aqueous liquid electrolytes. For example, when such a lithium ion secondary battery is charged and discharged in a high-temperature environment, the anions containing fluorine atoms decompose and generate fluorine ions, that is, hydrofluoric acid, as a decomposition product. The inventors of the present application have conceived a current collector that is capable of suppressing degradation of a current collector having a conductive layer formed on a resin film, the degradation being caused by decomposition products of a non-aqueous liquid electrolyte, specifically, capable of suppressing degradation of a current collector by suppressing peeling of the conductive layer from the resin film, and maintaining charge-discharge characteristics, as well as an electrode for a power storage device and a lithium ion secondary battery.

Hereinafter, embodiments of the current collector, electrode for a power storage device, and lithium ion secondary battery of the present disclosure will be described with reference to the drawings. The numerical values, shapes, materials, steps, order of the steps, and the like presented in the following description are merely examples, and various modifications can be made as long as there is no technical contradiction. Furthermore, each of the embodiments described below is merely an example, and various combinations thereof can be made as long as there is no technical contradiction.

The thicknesses, dimensions, shapes, and the like of the members shown in the drawings of the present disclosure may be exaggerated for the convenience of explanation. Furthermore, in the drawings of the present disclosure, some members may be shown in isolation, or depiction of some elements may be omitted, in order to avoid excessive complexity. Therefore, the dimensions of each of the members shown in the drawings of the present disclosure and the arrangement between the members may not reflect the dimensions of each of the members and the arrangement between the members in an actual device. The terms “perpendicular” and “orthogonal” in the present disclosure are not limited to two straight lines, sides, faces, and the like forming an angle of exactly 90°, and also include cases in which they form an angle that is within a range of about ±5° from 90°. Furthermore, the term “parallel” includes a case where two straight lines, sides, faces, and the like are at an angle within a range of about ±5° from 0°.

In the present specification, the term “cell” refers to a structure in which at least a pair of positive and negative electrodes are integrally assembled. The term “battery” in the present specification is used as a term that encompasses various forms of battery modules, battery packs, and the like, having one or more “cells” that are electrically connected to each other.

### First Embodiment

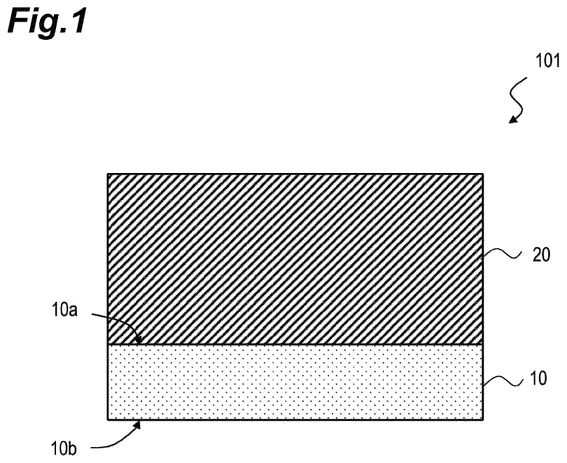

FIG. 1 is a schematic cross-sectional view showing an example of a current collector of the present embodiment. The current collector of the present embodiment can be used even as a current collector for either the positive electrode or the negative electrode of a power storage device such as a lithium ion secondary battery. The current collector 101 shown in FIG. 1 includes: a resin layer 10 having a first surface 10a and a second surface 10b located on the opposite side of the first surface 10a; and a first metal layer 20.

The resin layer 10 functions as a support of the first metal layer 20 in the current collector 101. The resin layer 10 has a density smaller than that of the first metal layer 20, and can thereby contribute to increasing the charging capacity per unit weight when the current collector 101 is applied to a power storage device.

The resin layer 10 has electrical insulation properties and contains a resin. The resin layer 10 may have thermoplastic properties. The resin layer 10 may contain at least one selected from the group consisting of polyethylene terephthalate (PET), polypropylene (PP), polyamide (PA), polyimide (PI), polyethylene (PE), polystyrene (PS), a phenol resin (PF), and an epoxy resin (EP). The resin layer 10 may be a single layer or may be configured by laminating a plurality of layers, such as two or more layers. In this case, at least one layer among the plurality of layers may contain a resin different from other layers.

The thickness of the resin layer 10 is, for example, 3 μm or greater and 12 μm or less. The thickness of the resin layer 10 may be 3 μm or greater and 6 μm or less. When the thickness of the resin layer 10 is 3 μm or greater, sufficient strength as the support is obtained. Furthermore, when the thickness of the resin layer 10 is 12 μm or less, the total thickness of the current collector 101 can be made small. For this reason, in a laminated-type lithium ion secondary battery in which a plurality of electrode pairs are laminated, the proportion occupied by the current collector, which is a part that does not contribute to energy storage, can be decreased, and the energy density can be increased. When the thickness of the resin layer 10 is 6 μm or less, the total thickness of the current collector 101 can be further decreased, and the energy density of the laminated-type lithium ion secondary battery can be increased.

The current collector 101 may further include an undercoat layer that is located between the resin layer 10 and the first metal layer 20. The undercoat layer can be provided in order to increase the bonding strength between the resin layer 10 and the first metal layer 20 or to suppress the formation of pinholes in the first metal layer 20. The undercoat layer may be a layer formed from an organic material such as an acrylic resin or a polyolefin resin, a layer containing a metal formed by sputtering, or the like.

The first metal layer 20 contains Al (aluminum) as a main component. The main component as used herein refers to, in a case where a member contains one or a plurality of constituent elements, the element that is contained in the largest proportion among the constituent elements as expressed in molar percentage. As long as the first metal layer 20 contains Al as a main component, the first metal layer 20 may further contain other metals.

The thickness d of the first metal layer 20 is, for example, 0.5 μm or greater and 3 μm or less. When the thickness d of the first metal layer 20 is 0.5 μm or greater, the electric resistance of the first metal layer 20 can be made small. For example, when a power storage device is produced, the energy loss due to resistance in the current collector can be made small. Furthermore, when the thickness of the first metal layer 20 is 3 μm or less, the proportion occupied by the first metal layer 20 in the entire current collector 101 becomes small, and it is easy to obtain the advantage of reducing the weight of the current collector using the resin layer 10. The thickness d of the first metal layer 20 may be 0.7 μm or greater and 2 μm or less.

The first metal layer 20 has strong peaks in the diffraction angle (2θ) range of 36° or greater and 41° or less and in the diffraction angle (2θ) range of 43° or greater and 48° or less, respectively, in the measurement by an X-ray diffraction method. Here, the highest X-ray diffraction peak in the diffraction angle (2θ) range of 36° or greater and 41° or less is a peak of Al(111), and the highest X-ray diffraction peak in the diffraction angle (2θ) range of 43° or greater and 48° or less is a peak of Al(200). Measurement by an X-ray diffraction method is performed using an Out-of-Plane method. That is, X-rays are made incident through the surface of the first metal layer 20, and the intensity of scattered X-rays is measured.

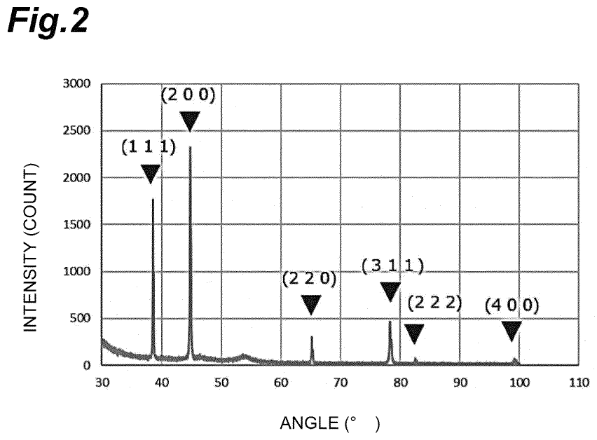

FIG. 2 shows an example of X-ray diffraction peaks of aluminum thin film. As shown in FIG. 2, the peak of the (111) plane is observed in the range of 36° or greater and 41° or less, and the peak of the (200) plane is observed in the range of 43° or greater and 48° or less. Since aluminum metal has an fcc structure, due to the extinction rule, a peak is observed only when the values of h, k, and l in the case of expressing the Miller indices as (h, k, l) are all even numbers or all odd numbers.

When the peak intensity ratio B/A using the intensity A of the highest X-ray diffraction peak in the diffraction angle (2θ) range of 36° or greater and 41° or less and the intensity B of the highest X-ray diffraction peak in the diffraction angle (2θ) range of 43° or greater and 48° or less is designated as r, the d and r of the first metal layer 20 satisfy the following Formula (1):

$$\begin{matrix}[ Mathematical Formula 2 ] & \\ 0 \leq \frac{\sqrt{r}}{{d}^{2}} \leq 2.1 & ( 1 )\end{matrix}$$

As will be described in detail in the following Examples, when r and d satisfy Formula (1), the first metal layer 20 has excellent resistance to non-aqueous liquid electrolytes.

More preferably, d and r of the first metal layer 20 satisfy the following Formula (2):

$$\begin{matrix}[ Mathematical Formula 3 ] & \\ 0 \leq \frac{\sqrt{r}}{{d}^{2}} \leq 1 & ( 2 )\end{matrix}$$

As a result, the volume resistivity of the first metal layer 20 is reduced, and a current collector having low resistance is obtained.

In Formulas (1) and (2), d is the value of the thickness of the first metal layer expressed in the unit of μm. The value of the thickness d of the first metal layer 20 is obtained by, for example, observation of a cross-section utilizing SEM.

It is preferable that r satisfies the following Formula (3):

$$r < 1 \qquad ( 3 )$$

When r satisfies Formula (3), the (111) orientation of the first metal layer 20 is increased, and a denser metal layer is obtained. Therefore, the resistance of the first metal layer 20 to a non-aqueous liquid electrolyte is further improved.

It is more preferable that the peak of Al(200) is hardly observed. That is, it is preferable that the peak intensity B of Al(200) is approximately the same as the baseline intensity in the measurement by an X-ray diffraction method. The expression “approximately the same” means that the intensity variations are substantially indistinguishable from the baseline noise in the measurement by an X-ray diffraction method. When the peak intensity B of Al(200) is approximately the same as the baseline intensity in the measurement by an X-ray diffraction method, it can be considered that substantially B=0. Therefore, in this case, it can be said that the value of √r/d² is equal to zero. In contrast to this, when the peak intensity B of Al(200) is large enough to be distinguishable from the baseline noise in the measurement by an X-ray diffraction method, √r/d² has a value larger than zero.

It is preferable that the orientation index of the (111) plane of aluminum in the first metal layer according to the Lotgering method with respect to a direction perpendicular to the first surface 10a of the resin layer 10 is 0.8 or greater. As a result, the (111) orientation of the first metal layer 20 is increased, and a denser metal layer is obtained.

Here, the orientation index of the (111) plane refers to the orientation index F according to the Lotgering method. The maximum value of the orientation index according to the Lotgering method is 1. An orientation index of 1 indicates perfect orientation, and an orientation index of 0 indicates no orientation. The orientation index F is determined by the following formulas using the intensity of an X-ray diffraction peak obtained by X-ray diffraction measurement of the layer (film) to be evaluated:

$$\begin{matrix}[ Mathematical Formula 4 ] & \\ F = \frac{( ρ - {ρ}_{0} )}{( 1 - {ρ}_{0} )} & \end{matrix}$$

$${ρ}_{0} = \frac{\sum {I}_{0} ( 111 )}{\sum {I}_{0} ( hkl )}$$

$$ρ = \frac{\sum I ( 111 )}{\sum I ( hkl )}$$

I₀(111) represents the intensity of the X-ray diffraction peak of the (111) plane obtained by X-ray diffraction measurement of a non-oriented Al film. I₀(hkl) represents the intensity of all diffraction peaks obtained by X-ray diffraction measurement of a non-oriented Al film. Furthermore, a non-oriented Al film means an Al film that exhibits an intensity pattern of X-ray diffraction peaks close to the intensity pattern of X-ray diffraction peaks of a standard sample of aluminum published in JCPDS (Joint Committee on Powder Diffraction Standards).

I(111) represents the intensity of the X-ray diffraction peak of the (111) plane obtained by X-ray diffraction measurement of a layer (film) to be evaluated. I(hkl) represents the intensity of all diffraction peaks obtained by X-ray diffraction measurement of a layer (film) to be evaluated.

Incidentally, the orientation index F according to the Lotgering method may have a negative value. This can occur when the intensity of the X-ray diffraction peak in the oriented plane for which the orientation index F is determined, which is obtained from the layer (film) to be evaluated, is smaller than the intensity obtained from a non-oriented film. When the orientation index F determined by the above-mentioned formula has a negative value, for example, there is a possibility that the layer to be evaluated may be strongly oriented in an orientation direction other than the oriented plane for which the orientation index F is determined.

The first metal layer 20 may be formed by any method as long as the first metal layer 20 includes the above-mentioned characteristics. The first metal layer 20 can be formed on the resin layer 10 by, for example, a thin film forming technology such as a sputtering method or a vacuum vapor deposition method. In this case, the thickness of the first metal layer 20, the peak intensity of Al(111) and the peak intensity of Al(200) in the first metal layer 20, and the like can be adjusted by changing conditions such as the film forming time, the ultimate vacuum level during film forming, the film forming rate, the heating temperature for the substrate, and the bias voltage.

According to the present embodiment, as the first metal layer 20 satisfies the above-described Formula (1), the current collector 101 exhibits excellent resistance to liquid electrolytes. Therefore, a lithium ion secondary battery including the current collector 101 of the present embodiment has excellent reliability with suppressed degradation of the battery characteristics.

### Second Embodiment

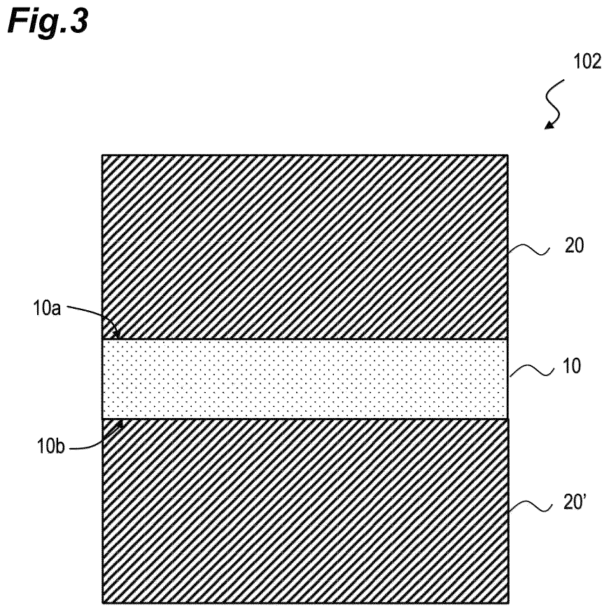

FIG. 3 is a schematic cross-sectional view illustrating an example of the current collector of the present embodiment. The current collector 102 of the present embodiment is different from the current collector 101 of the first embodiment in that a conductive layer is provided on both surfaces of the resin layer 10.

The current collector 102 includes a resin layer 10, a first metal layer 20, and a second metal layer 20′. As described in the first embodiment, the first metal layer 20 is disposed on the first surface 10a. On the other hand, the second metal layer 20′ is disposed on the second surface 10b of the resin layer 10.

Similarly to the first metal layer 20, the second metal layer 20′ also contains aluminum as a main component. The thickness d′ of the second metal layer 20′ is preferably 0.5 μm or more and 3 μm or less. In measurement of the second metal layer 20′ by an X-ray diffraction method, when the peak intensity ratio B′/A′ between the intensity A′ of the highest X-ray diffraction peak in the diffraction angle (2θ) range of 36° or greater and 41° or less and the intensity B′ of the highest X-ray diffraction peak in the diffraction angle (2θ) range of 43° or greater and 4820 or less is designated as r′, d′ and r′ satisfy the following Formula (4):

$$\begin{matrix}[ Mathematical Formula 5 ] & \\ 0 \leq \frac{\sqrt{{r}^{′}}}{{d}^{′2}} \leq 2.1 & ( 4 )\end{matrix}$$

As a result, the second metal layer 20′ also has excellent resistance to non-aqueous liquid electrolytes.

More preferably, d′ and r′ of the second metal layer 20′ satisfy the following Formula (5):

$$\begin{matrix}[ Mathematical Formula 6 ] & \\ 0 \leq \frac{\sqrt{{r}^{′}}}{{d}^{′2}} \leq 1 & ( 5 )\end{matrix}$$

As a result, the volume resistivity of the second metal layer 20′ becomes small, and a current collector having low resistance is obtained.

It is preferable that r′ satisfies the following Formula (6):

$${r}^{′} < 1. \qquad ( 6 )$$

When Formula (6) is satisfied, the (111) orientation of the second metal layer 20′ is increased, and a denser metal layer is obtained.

It is preferable that the orientation index of the (111) plane of aluminum in the second metal layer 20′ according to the Lotgering method with respect to a direction perpendicular to the second surface 10b of the resin layer 10 is 0.8 or greater. As a result, the (111) orientation of the second metal layer 20′ is increased, and a denser metal layer is obtained.

According to the current collector 102, since the current collector 102 includes the first metal layer 20 on the first surface 10a of the resin layer 10 and includes the second metal layer 20′ on the second surface 10b, an electrode can be formed on both surfaces of the current collector 102. Therefore, the proportion occupied by the resin layer in a power storage device can be reduced, and the battery capacity per unit area can be increased.

### Third Embodiment

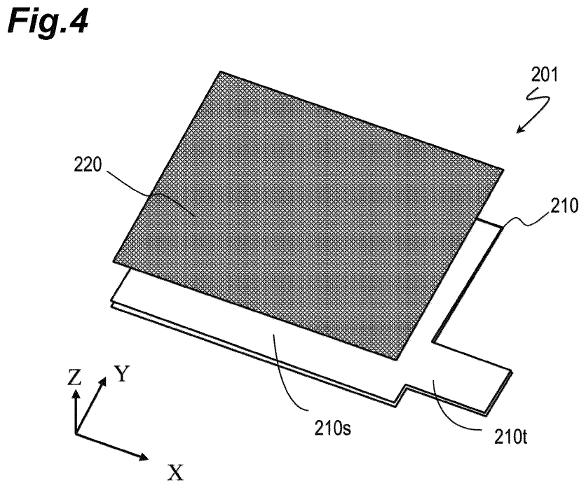

An embodiment of an electrode for a power storage device will be described. The electrode for a power storage device of the present embodiment can be used for either a positive electrode or a negative electrode of a power storage device. FIG. 4 is an exploded perspective view of an electrode 201 for a power storage device. The electrode 201 for a power storage device includes a current collector 210 and an active material layer 220. The current collector 210 includes a first portion 210s and a second portion 210t, and the active material layer 220 is disposed on the first portion 210s. The active material layer 220 is not provided on the second portion 210t, and the second portion 210t functions as a tab for electrical connection to the outside. The active material layer 220 can contain an active material that is oxidized and reduced upon charging (or power storage) and discharging. The current collector 210 supports the active material layer 220, supplies electrons to the active material layer 220, and receives electrons from the active material layer 220.

As the current collector 210, the current collector 101 or the current collector 102 described in the first embodiment or the second embodiment can be used. In the case of using the current collector 102, another active material layer that is not shown in FIG. 4 is disposed on the first portion 210s on the back surface side (side where the active material layer 220 is not disposed) of the current collector 210.

The active material layer 220 may include a positive electrode active material or negative electrode active material that intercalates and deintercalates lithium ions. The positive electrode active material includes, for example, a composite metal oxide containing lithium. Examples of the composite metal oxide containing lithium include lithium cobaltate (LiCoO₂), lithium nickelate (LiNiO₂), lithium manganate (LiMnO₂), lithium manganese spinel (LiMn₂O₄), lithium vanadium compound (LiV₂O₅), olivine type LiMPO₄ (provided that M is one or more kinds of elements selected from the group consisting of Co, Ni, Mn, Fe, Mg, Nb, Ti, Al, and Zr, or vanadium oxide), lithium titanate (Li₄Ti₅O₁₂), a composite metal oxide represented by general formula: LiNiₓCo_{y}Mn_{z}MₐO₂ (x+y+z+a=1, 0≤x<1, 0≤y<1, 0≤z<1, 0≤a<1, M in the above general formula is one or more kinds of elements selected from the group consisting of Al, Mg, Nb, Ti, Cu, Zn, and Cr), and a composite metal oxide represented by general formula: LiNiₓCo_{y}Al₂O₂ (0.9<x+y+z<1.1). The positive electrode active material may contain polyacetylene, polyaniline, polypyrrole, polythiophene, polyacene, and the like as a material capable of intercalating and deintercalating lithium ions.

The active material layer 220 may further contain at least one of a binder and a conductive aid. Various known materials can be used as the binder. In a case where the electrode 201 for a power storage device is used as a positive electrode, fluororesins such as polyvinylidene fluoride (PVDF), polytetrafluoroethylene (PTFE), a tetrafluoroethylene-hexafluoropropylene copolymer (FEP), a tetrafluoroethylene-perfluoroalkyl vinyl ether copolymer (PFA), an ethylene-tetrafluoroethylene copolymer (ETFE), polychlorotrifluoroethylene (PCTFE), an ethylene-chlorotrifluoroethylene copolymer (ECTFE), and polyvinyl fluoride (PVF) can be used as the binder in the active material layer 220.

Vinylidene fluoride-based fluororubber may also be used as the binder. For example, vinylidene fluoride-hexafluoropropylene-based fluororubber (VDF-HFP-based fluororubber), vinylidene fluoride-hexafluoropropylene-tetrafluoroethylene-based fluororubber (VDF-HFP-TFE-based fluororubber), vinylidene fluoride-pentafluoropropylene-based fluororubber (VDF-PFP-based fluororubber), vinylidene fluoride-pentafluoropropylene-tetrafluoroethylene-based fluororubber (VDF-PFP-TFE-based fluororubber), vinylidene fluoride-perfluoromethyl vinyl ether-tetrafluoroethylene-based fluororubber (VDF-PFMVE-TFE-based fluororubber), and vinylidene fluoride-chlorotrifluoroethylene-based fluororubber (VDF-CTFE-based fluororubber) may be applied to the binder of the active material layer 220.

Examples of the conductive aid include carbon materials such as carbon powder and carbon nanotubes. Carbon black or the like can be applied to the carbon powder. Other examples of the conductive aid of the active material layer 220 in a case where the electrode 201 for a power storage device is used as the positive electrode, include metal powders of nickel, stainless steel, and iron; and powders of conductive oxides such as ITO. Two or more kinds of the above-mentioned materials may be mixed and incorporated into the active material layer 220.

The negative electrode active material may contain a carbon material. Examples of the carbon material include natural or artificial graphite, carbon nanotubes, non-graphitizable carbon, easily graphitizable carbon (soft carbon), and low-temperature fired carbon. The negative electrode active material may contain a material other than the carbon material. For example, the negative electrode active material may contain alkali metals and alkaline earth metals, such as lithium metal; metals such as tin or silicon, which can form compounds with metals such as lithium; silicon-carbon composite materials; amorphous compounds mainly composed of oxides (SiOₓ (0<x<2), tin dioxide and the like); and particles of lithium titanate (Li₄Ti₅O₁₂) and the like.

Regarding the binder and the conductive aid of the active material layer 220 in the case of applying the electrode 201 for a power storage device to the negative electrode, the above-mentioned binders and conductive aids can be used similarly. Furthermore, cellulose, styrene-butadiene rubber, ethylene-propylene rubber, polyimide, polyamideimide, acrylic resin, and the like may also be used as the binder for the negative electrode.

The electrode for a power storage device for use in the positive electrode and the negative electrode can be produced by a known production method. In the electrode for a power storage device of the present embodiment, adhesion between the resin layer and the conductive layer of the current collector is increased. For this reason, even when a lithium ion secondary battery including the electrode for a power storage device of the present embodiment is used under conditions in which the electrolyte is easily decomposed, for example, at high temperature, peeling of the conductive layer from the resin layer can be suppressed, and deterioration of the battery characteristics due to degradation of the current collector can be suppressed.

### Fourth Embodiment

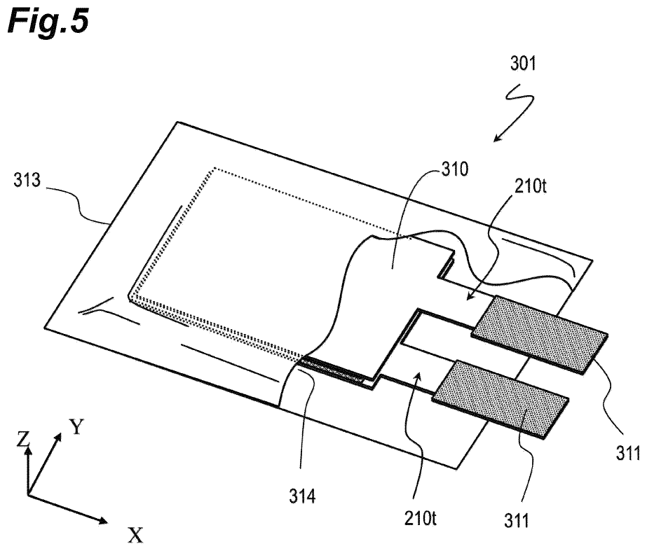

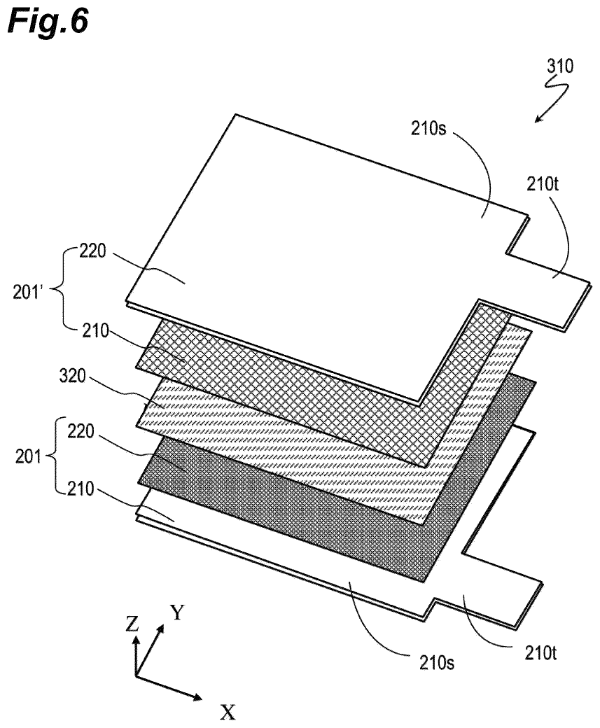

An embodiment of a lithium ion secondary battery will be described. FIG. 5 is a schematic external view illustrating an example of a lithium ion secondary battery, and FIG. 6 is an exploded perspective view showing a cell taken out from the lithium ion secondary battery shown in FIG. 5. Here, a so-called pouch type or laminate type lithium ion secondary battery will be taken as an example as the lithium ion secondary battery. The lithium ion secondary battery shown in the drawing is a single layer type but may be a laminated type. In the example shown in the drawing, the positive electrode, the separator, and the negative electrode constituting the cell are stacked along the Z-direction in the drawing.

The lithium ion secondary battery 301 shown in FIG. 5 includes a cell 310, a pair of leads 311 connected to the cell 310, an exterior body 313 covering the cell 310, and an electrolyte 314.

As schematically shown in FIG. 6, the cell 310 includes an electrode 201 for a power storage device, an electrode 201′ for a power storage device, and a separator 320 disposed therebetween. In the example of the drawing, the cell 310 is a single layer cell including a pair of electrodes.

To each of the electrode 201 for a power storage device and the electrode 201′ for a power storage device, a structure similar to that of the electrode for a power storage device described in the third embodiment may be applied. In this example, one of the electrode 201 for a power storage device and the electrode 201′ for a power storage device is configured as a positive electrode containing a positive electrode active material, and the other one is configured as a negative electrode containing a negative electrode active material.

The separator 320 is an insulating porous material. For example, a single-layered film or laminated film of polyolefins such as polyethylene and polypropylene; a nonwoven fabric of at least one kind of fiber selected from the group consisting of cellulose, polyester, polyacrylonitrile, polyimide, polyamide (for example, aromatic polyamide), polyethylene, and polypropylene; and a porous film can be applied to the separator 320.

An electrolyte 314 is further disposed in the space inside the exterior body 313. The electrolyte 314 is a non-aqueous electrolyte containing lithium ions and may be, for example, a non-aqueous liquid electrolyte containing lithium ions. When a non-aqueous liquid electrolyte is applied to the electrolyte 314, typically, a sealing material (for example, a resin film of polypropylene or the like, not shown in FIG. 5) for preventing leakage of the non-aqueous liquid electrolyte is disposed between the exterior body 313 and the lead 311.

As the electrolyte 314, for example, a non-aqueous liquid electrolyte containing a metal salt such as a lithium salt and an organic solvent can be used. As the lithium salt, for example, LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, and LiBOB can be used. These lithium salts may be used singly, or two or more kinds thereof may be used as mixtures.

As the solvent for the electrolyte 314, for example, a cyclic carbonate and a chain-like carbonate can be used. Examples of the solvent for the electrolyte 314 include ethylene carbonate, propylene carbonate, butylene carbonate, and dimethyl carbonate.

The lithium ion secondary battery 301 can be produced by, for example, the following method. First, electrodes 201 and 201′ for a power storage device are produced as described in the above-described embodiment. Thereafter, the electrode 201 for a power storage device and the electrode 201′ for a power storage device are held, with a separator 320 interposed therebetween, such that the active material layers face each other, and these members are inserted into the space of an exterior body 313. An electrolyte 314 is disposed in the space of the exterior body 313, the exterior body 313 is sealed, and thereby the lithium ion secondary battery 301 is completed.

According to the lithium ion secondary battery 301, adhesion between the resin layer and the conductive layer of the current collector is increased. For this reason, even in a case where the lithium ion secondary battery is used at high temperatures, the conductive layer is further suppressed from being peeled from the resin layer, and deterioration of the battery characteristics due to degradation of the current collector is suppressed.

### EXAMPLES

Current collectors of Examples and current collectors of Reference Examples were produced, and characteristics thereof were evaluated.

### Production of Sample

Current collectors of Example 1 to Example 15 and Reference Example 1 to Reference Example 8 were produced by the following method. In Table 1, the conditions for forming the first metal layer of the current collectors of Reference Examples 1 to 8 and Examples 1 to 15 are shown.

### Example 1 to Example 15

A current collector 102 including the structure shown in FIG. 3 was produced. A polyethylene terephthalate resin having a thickness of 6 μm was used for the resin layer 10. The first metal layer 20 and the second metal layer 20′ were formed by vacuum vapor deposition of Al. The thickness of each of the first metal layer 20 and the second metal layer 20′ was adjusted by the film forming time. In order to produce samples of various crystalline states, as shown in Table 1, the ultimate vacuum level and the film forming rate during the formation of these metal layers were varied among these current collectors. Table 1 shows the ultimate true pressure and the film forming rate when the first metal layers 20 of the current collectors of Example 1 to Example 15 were formed. The classification of the ultimate pressure and the film forming rate shown in Table 1 is as shown in Table 2 and Table 3.

### Reference Example 1 to Reference Example 8

The current collectors of Reference Examples 1 to 8 were produced by a procedure similar to that of Example 1 to Example 15. Table 1 shows the ultimate pressure and the film forming rate when the first metal layers 20 of the current collectors of Reference Example 1 to Reference Example 8. The classification of the ultimate pressure and the film forming rate shown in Table 1 is as shown in Table 2 and Table 3.

### Evaluation

### (1) Thickness of First Metal Layer

The thickness d of the first metal layer 20 in Example 1 to Example 15 and Reference Example 1 to Reference Example 8 was determined by SEM observation of a cross-section of each current collector.

### (2) Measurement by X-Ray Diffraction Method

The crystallinity of the first metal layer 20 in each of the current collectors of Example 1 to Example 15 and Reference Example 1 to Reference Example 8 was evaluated using an X-ray diffraction method.

The apparatus and measurement conditions used for the measurement are as follows.
Apparatus name: manufactured by Malvern Panalytical, Ltd., PANalytical X'Pert PRO
Accelerating voltage: 45 kV
Current: 40 mA
Scan speed: 7 deg./min.
Sampling width: 0.008 deg.

From the obtained X-ray diffraction charts, the peak intensity A of Al(111) and the peak intensity B of Al(200) were determined for each sample, and the value of r=B/A was calculated. In addition, the value of √r/d² was determined. Furthermore, the Lotgering factor of Al(111) was determined from the peak intensity A of Al(111).

### (3) Surface Resistance

The surface resistance of the first metal layer 20 in each of the current collectors of Example 1 to Example 15 and Reference Example 1 to Reference Example 8 was measured using a four-terminal measuring device (manufactured by Nittoseiko Analytech Co., Ltd., LORESTA AX MCP-T370). The volume resistivity of the first metal layer 20 of each material was determined from the value of surface resistance and the thickness d of the first metal layer 20.

### (4) Resistance to Liquid Electrolyte

The current collectors of Example 1 to Example 15 and Reference Example 1 to Reference Example 8 were maintained in an environment similar to a lithium ion secondary battery, and the presence or absence of peeling of the conductive layer was evaluated. Specifically, a non-aqueous liquid electrolyte of dimethyl carbonate containing LiPF₆ at a concentration of 1 mol % was prepared, water was added to the non-aqueous liquid electrolyte at a proportion of 1000 ppm by mass, and then the mixture was placed in a container. The produced current collector was immersed in the non-aqueous liquid electrolyte in the container, and the whole was sealed with a laminate film and stored in a constant-temperature chamber at 85° C. for 72 hours (high-temperature storage). Thereafter, the current collector was taken out from the laminate film and washed with an organic solvent.

For the current collectors obtained after the high-temperature storage, the resistance to liquid electrolytes was evaluated. The evaluation of the resistance to liquid electrolytes was carried out by the following method. The surface of a conductive layer of the current collector after the high-temperature storage was rubbed with a cotton swab, and when a portion of the conductive layer adhered to the cotton swab, it was recognized that the conductive layer was peeled from the resin layer, and the current collector was considered to be unacceptable (POOR). When peeling of the conductive layer due to rubbing using a cotton swab was not recognized, the current collector was considered to be acceptable (GOOD).

Table 1 shows the evaluation results.

TABLE 1

| | | | | | | | Surface | Volume | Resistance | | Film |
|---|---|---|---|---|---|---|---|---|---|---|---|
| | | (111) Peak | (200) Peak | | | Lotgering | resistance | resistivity | to liquid | Ultimate | forming |
| Sample | d(μm) | intensity | intensity | r | √r/d² | factor | (mΩ/sq) | (μΩ · cm) | electrolyte | pressure | rate |
| Reference | 0.99 | 835 | 5012 | 6.0 | 2.5 | −0.87 | 51 | 5.0 | POOR | HIGH | LOW |
| Example 1 | | | | | | | | | | | |
| Reference | 0.33 | 6104 | 113 | 0.02 | 1.2 | 0.92 | 147 | 4.9 | POOR | MEDIUM | LOW |
| Example 2 | | | | | | | | | | | |
| Reference | 0.50 | 2564 | 980 | 0.4 | 2.5 | 0.12 | 95 | 4.8 | POOR | HIGH | LOW |
| Example 3 | | | | | | | | | | | |
| Reference | 0.50 | 371 | 3352 | 9.0 | 12.0 | −0.88 | 120 | 6.0 | POOR | HIGH | LOW |
| Example 4 | | | | | | | | | | | |
| Reference | 0.60 | 689 | 3814 | 5.5 | 6.5 | −0.84 | 90 | 5.4 | POOR | HIGH | LOW |
| Example 5 | | | | | | | | | | | |
| Reference | 0.80 | 919 | 2369.5 | 2.6 | 2.5 | −0.61 | 66 | 5.3 | POOR | HIGH | LOW |
| Example 6 | | | | | | | | | | | |
| Reference | 0.80 | 913 | 1837 | 2.0 | 2.2 | −0.59 | 64 | 5.1 | POOR | HIGH | LOW |
| Example 7 | | | | | | | | | | | |
| Reference | 1.20 | 473 | 5530 | 11.7 | 2.4 | 0.00 | 41 | 4.9 | POOR | HIGH | LOW |
| Example 8 | | | | | | | | | | | |
| Example 1 | 0.60 | 2957 | 1471 | 0.5 | 2.0 | 0.07 | 81 | 4.9 | GOOD | HIGH | MEDIUM |
| Example 2 | 0.70 | 160260 | 35 | 0.0002 | 0.03 | 1.00 | 52 | 3.6 | GOOD | VERY LOW | HIGH |
| Example 3 | 0.80 | 931 | 1311 | 1.4 | 1.9 | −0.40 | 62 | 5.0 | GOOD | HIGH | MEDIUM |
| Example 4 | 0.90 | 963 | 2376 | 2.5 | 1.9 | −0.52 | 58 | 5.2 | GOOD | HIGH | MEDIUM |
| Example 5 | 0.90 | 1680 | 2251 | 1.3 | 1.4 | −0.35 | 57 | 5.1 | GOOD | MEDIUM | LOW |
| Example 6 | 0.92 | 2908 | 1749 | 0.6 | 0.9 | 0.03 | 48 | 4.4 | GOOD | LOW | LOW |
| Example 7 | 0.92 | 76470 | 160 | 0.0021 | 0.05 | 0.99 | 42 | 3.9 | GOOD | VERY LOW | MEDIUM |
| Example 8 | 1.02 | 45399 | 430 | 0.01 | 0.1 | 0.83 | 39 | 4.0 | GOOD | VERY LOW | LOW |
| Example 9 | 1.10 | 795 | 5004 | 6.3 | 2.1 | −0.87 | 44 | 4.8 | GOOD | MEDIUM | LOW |
| Example 10 | 1.22 | 962 | 1863 | 1.9 | 0.9 | −0.44 | 37 | 4.5 | GOOD | MEDIUM | MEDIUM |
| Example 11 | 1.30 | 3311 | 1566 | 0.5 | 0.4 | −0.02 | 33 | 4.3 | GOOD | MEDIUM | HIGH |
| Example 12 | 1.30 | 537 | 5378 | 10.0 | 1.9 | −0.90 | 37 | 4.8 | GOOD | HIGH | MEDIUM |
| Example 13 | 1.50 | 87163 | 2612 | 0.03 | 0.08 | 0.70 | 28 | 4.2 | GOOD | LOW | MEDIUM |
| Example 14 | 2.00 | 287 | 6135 | 21.4 | 1.2 | −0.95 | 26 | 5.2 | GOOD | HIGH | LOW |
| Example 15 | 2.00 | 450 | 5741 | 12.8 | 0.9 | −0.92 | 22 | 4.4 | GOOD | HIGH | MEDIUM |

TABLE 2

| Ultimate pressure P (Pa) | Classification |
|---|---|
| 6 × 10⁻² < P | HIGH |
| 3 × 10⁻² < P ≤ 6 × 10⁻² | MEDIUM |
| 1 × 10⁻² < P ≤ 3 × 10⁻² | LOW |
| P ≤ 1 × 10⁻² | VERY LOW |

TABLE 3

| Film forming rate R (μm · m/min) | Classification |
|---|---|
| 8 < P | HIGH |
| 4 < P ≤ 8 | MEDIUM |
| 0 < P ≤ 4 | LOW |

### Results and Discussion

As shown in Table 1, for the current collectors of Example 1 to Example 15 and Reference Example 1 to Reference Example 8, the ranges of d, r, and √r/d² were such that 0.33≤d≤2.00, 0.01≤r≤21.4, and 0.03≤√r/d²≤2.1. When r and d satisfy the relationship of Formula (1), that is, when the value of √r/d² is 2.1 or less, the current collectors of all the samples except for Reference Example 2 exhibit acceptable (GOOD) resistance to liquid electrolytes. On the other hand, when the value of √r/d² is greater than 2.1, the resistance to liquid electrolyte is unacceptable (POOR). The reason why the resistance to liquid electrolyte of the current collector of Reference Example 2 is poor is believed to be that the thickness d of the first metal layer 20 is smaller than 0.5 μm.

The volume resistivity of the first metal layer 20 in Examples 1 to 15 is in the range of 3.6 to 5.2 μΩ·cm, while when r and d satisfy the relationship of Formula (2), that is, when the value of √r/d² is 1 or less, the volume resistivity of the first metal layer 20 is in the range of 3.6 to 4.52 μΩ·cm, and it is understood that a first metal layer 20 having lower resistance is obtained.

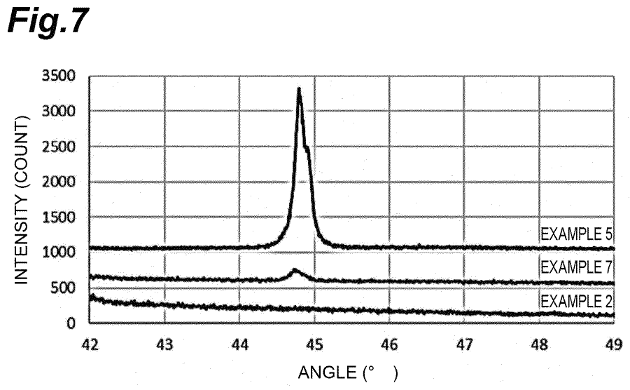

In a sample in which the Lotgering factor of Al(111) has a negative value, except in Example 11, the intensity B of the Al(200) peak is larger than the intensity A of the Al(111) peak. Furthermore, it is believed that the peak intensity A of Al(111) and the peak intensity B of Al(200) are in a trade-off relationship. FIG. 7 shows the diffraction angle (2θ) range of 43° to 48° in which the peak of Al(200) is observed, in the X-ray diffraction charts obtained from the samples of Examples 2, 5, and 7. The peak intensity A of Al(111) decreases in the order of Example 2, Example 7, and Example 5, whereas the peak intensity B of Al(200) increases in the order of Example 2, Example 7, and Example 5. In Example 2, the peak of Al(200) is not observed in the range of 43° or greater and 48° or less, and the peak intensity of Al(200) is approximately the same as the baseline intensity of the X-ray diffraction chart. That is, in the material of Example 2, it can be said that the peak intensity B is substantially zero.

When comparison is made between the results of the current collectors of Example 5 and Example 6, and between the results of the current collectors of Example 11 and Example 12, each pair having approximately the same thickness of the first metal layer 20, the sample in which the peak intensity A of Al(111) is larger than the peak intensity B of Al(200) has a smaller value of volume resistivity. This is believed to be because voids and the like in the first metal layer 20 are reduced as the orientation of Al(111) increases, and consequently, the increased denseness decreases the volume resistivity. It is believed that as the peak intensity B of Al(200) increases, that is, the orientation of Al(200) increases, voids and the like in the first metal layer 20 are reduced; however, according to the Examples, the peak intensity A of Al(111) is likely to exhibit a larger value than that of Al(200), that is, it is believed that an Al film having a highly crystalline (111) orientation is likely to be obtained, and the volume resistivity of the first metal layer 20 is likely to be decreased. According to the Examples, it is believed that when the Lotgering factor of Al(111) is 0.8 or greater, the volume resistivity of the first metal layer 20 can be made to be 4 μΩ·cm or less, and a current collector having lower resistance can be realized.

When the first metal layer 20 is formed by a vacuum vapor deposition method, there is a tendency that as the ultimate pressure is lower, the first metal layer 20 is likely to be oriented in the (111) plane. From these Examples and Reference Examples, it was found that the current collector of the present embodiment acquires excellent resistance to liquid electrolytes by satisfying the relationship of Formula (1).

### INDUSTRIAL APPLICABILITY

The electrode for a power storage device according to the embodiments of the present disclosure is useful as a power source for various electronic devices, electric motors, and the like. The power storage device according to the embodiments of the present disclosure can be applied to, for example, power sources for vehicles represented by bicycles and passenger cars, power sources for communication devices represented by smartphones, power sources for various sensors, and power sources for unmanned extended vehicles (UxV).

### REFERENCE SIGNS LIST

10: resin layer, 10a: first surface, 10b: second surface, 20: first metal layer, 20′: second metal layer, 101, 102, 210: current collector, 201, 201′: electrode for power storage device, 210: current collector, 210s: first portion, 210t: second portion, 220: active material layer, 301: lithium ion secondary battery, 310: cell, 311: lead, 313: exterior body, 314: electrolyte, 320: separator.

1. A current collector comprising:
a resin layer having a first surface and a second surface located on an opposite side of the first surface; and
a first metal layer located on the first surface,
wherein the first metal layer contains aluminum as a main component,
the first metal layer has a thickness d of 0.5 μm or greater and 3 μm or less, and
in measurement of the first metal layer by an X-ray diffraction method, when a peak intensity ratio B/A between an intensity A of a highest X-ray diffraction peak in a diffraction angle (2θ) range of 36° or greater and 41° or less, and an intensity B of a highest X-ray diffraction peak in a diffraction angle (2θ) range of 43° or greater and 48° or less is designated as r, d and r satisfy the following Formula (1):
$$\begin{matrix}[ Mathematical Formula 1 ] & \\ 0 \leq \frac{\sqrt{r}}{{d}^{2}} \leq 2.1 & ( 1 )\end{matrix}$$

2. The current collector according to claim 1, wherein
the d is 0.7 μm or greater and 2 μm or less, and
the d and the r satisfy the following Formula (2):
$$\begin{matrix}[ Mathematical Formula 2 ] & \\ 0 \leq \frac{\sqrt{r}}{{d}^{2}} \leq 1 & ( 2 )\end{matrix}$$

3. The current collector according to claim 1, wherein
the highest X-ray diffraction peak in a diffraction angle (2θ) range of 36° or greater and 41° or less is a peak of a (111) plane of aluminum, and
an orientation index of the (111) plane of aluminum in the first metal layer according to a Lotgering method with respect to a direction perpendicular to the first surface of the resin layer is 0.8 or greater.

4. The current collector according to claim 1, wherein the intensity B of the highest X-ray diffraction peak in the diffraction angle (2θ) range of 43° or greater and 48° or less is approximately the same as a baseline intensity in the measurement by an X-ray diffraction method.

5. The current collector according to claim 1, wherein the r satisfies the following Formula (3):
r<1 (3).

6. The current collector according to claim 1, wherein
the current collector further comprises a second metal layer located on the second surface,
the second metal layer contains aluminum as a main component,
the second metal layer has a thickness d′ of 0.5 μm or greater and 3 μm or less, and
in measurement of the second metal layer by an X-ray diffraction method, when a peak intensity ratio B′/A′ between an intensity A′ of a highest X-ray diffraction peak in a diffraction angle (2θ) range of 36° or greater and 41° or less, and an intensity B′ of a highest X-ray diffraction peak in a diffraction angle (2θ) range of 43° or greater and 48° or less is designated as r′, d′and r′ satisfy the following Formula (4):
$$\begin{matrix}[ Mathematical Formula 3 ] & \\ 0 \leq \frac{\sqrt{{r}^{′}}}{{d}^{′2}} \leq 2.1 & ( 4 )\end{matrix}$$

7. The current collector according to claim 1, wherein the resin layer contains at least one selected from the group consisting of polyethylene terephthalate, polypropylene, polyamide, polyimide, polyethylene, polystyrene, a phenol resin, and an epoxy resin.

8. An electrode for a power storage device, comprising:
the current collector according to claim 1; and
an active material layer located on the first metal layer of the current collector.

9. An electrode for a power storage device, comprising:
the current collector according to claim 6;
a first active material layer located on the first metal layer of the current collector; and
a second active material layer located on the second metal layer of the current collector.

10. A lithium ion secondary battery, comprising:
a positive electrode including the electrode for a power storage device according to claim 8;
a negative electrode including a negative electrode active material layer and a negative electrode current collector;
a separator disposed between the negative electrode and the positive electrode; and
a non-aqueous electrolyte containing lithium ions.
